(19) United States
(12) Patent Application Publication
(10) Pub. No.: US 2026/0368679 A1
(43) Pub. Date: Nov. 19, 2026

(54) METHOD AND SYSTEM FOR PREDICTING A GAME PERIOD TO MOTIVATE AGENTS TO REACH A TARGET KEY PERFORMANCE INDICATOR (KPI), IN A CONTACT CENTER

(71) Applicant: NICE LTD., Ra'anana (IL)

(72) Inventors: Yuval SHACHAF, Tzur Moshe (IL); Eran ROSEBERG, Hogla (IL); Dror POPOVICH, Raanana (IL)

(21) Appl. No.: 19/211,345

(22) Filed: May 19, 2025

(51) Int. Cl. G06Q 10/0639; H04M 3/51

(52) U.S. Cl. CPC G06Q 10/06393; H04M 3/5175; H04M 2203/1066; H04M 2203/401

(57) ABSTRACT

A computerized-method for predicting a game period to motivate agents to reach a target KPI, in a contact-center. The computerized-method includes: (i) training a machine learning model to predict the game period to motivate agents to reach the target KPI; (ii) configuring a gamification application to schedule a new game for one or more agents by: a) receiving the target KPI, value of the target KPI and a start date for the game and storing in a game database; b) automatically operating the trained machine learning model to predict the game period to motivate agents to reach the target KPI starting from the received start date for the game; and c) calculating an end date for the game based on the predicted game period; and (iii) configuring the gamification application to operate the new game from the received start-date till the calculated end-date to the one or more agents.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever

### TECHNICAL FIELD

The present disclosure relates to the field of predicting a game period to motivate agents to reach a target Key Performance Indicator (KPI), in a contact center.

### BACKGROUND

In contact centers, games are highly effective and engaging tools for agents to improve their work and achieve Key Performance Indicator (KPI) targets set by the organization and supervisors. These KPIs include metrics such as average handling time, minimum hold time, or adherence to specific standards defined by managers. Defining relevant KPIs and challenges within games to enhance agent performance is complex. It requires analyzing historical data and past performances. Supervisors currently use various analytics tools to review past KPIs and performance, assessing the effectiveness of previous games by comparing agents' performance with and without the game. To streamline this process, there is a need for an automated Performance Management (PM) game period definition as part of game recommendations based on historical data. A recommended game definition should include the optimal period in days after which the game is no longer effective and does not improve the target KPI.

Currently, performance management systems that implement game applications don't measure the effectiveness of a game over time. Accordingly, there is a need for a technical solution for predicting the game's effectiveness on a target KPI for agents or groups with specific attributes and skills, day by day. There is a need for a technical solution that will identify the optimal point when the game is no longer effective and then adjust the game period accordingly to fit the participants' attributes and skills, and the target KPI.

### SUMMARY

There is thus provided, in accordance with some embodiments of the present disclosure, a computerized-method for predicting a game period to motivate agents to reach a target Key Performance Indicator (KPI), in a contact center.

In accordance with some embodiments of the present disclosure, the computerized-method may include: (i) training a machine learning model to predict the game period to motivate agents to reach the target KPI; (ii) configuring a gamification application to schedule a new game for one or more agents by: a) receiving the target KPI, value of the target KPI and a start date for the game and storing in a game database; b) automatically operating the trained machine learning model to predict the game period to motivate agents to reach the target KPI starting from the received start date for the game; and c) calculating an end date for the game based on the predicted game period; and (iii) configuring the gamification application to operate the new game from the received start date till the calculated end date to the one or more agents.

Furthermore, in accordance with some embodiments of the present disclosure, the training of the machine learning models may include: (i) collecting interactions data from the Automatic call distributor (ACD), game data and agents data during a preconfigured time that the game was running; (ii) parsing and merging the collected interactions data and agents data by a period and agent; (iii) creating labeled training sets by marking the target KPI; (iv) training a control prediction model to predict a control-KPI for each future period in a plurality of a preconfigured number of future periods when the game is not running; (v) training a treatment prediction model to predict a treatment-KPI for each future period in the plurality of the preconfigured number future periods when the new game is running; (vi) [generating a KPI-curve from the predicted control-KPI subtracted from the treatment-KPI] of each future period in the plurality of the preconfigured number of future periods; and (vii) determining the future period of an optimum point on the KPI-curve as the predicted game period by operating an optimum-period algorithm.

Furthermore, in accordance with some embodiments of the present disclosure, the interactions data may include: (i) average KPIs; (ii) interaction type; (iii) interaction duration, (iv) a timestamp; (v) attributes of agent; and (vi) game parameters. The agents' data may include: (i) skills; (ii) KPIs; (iii) tenure; (iv) team; (v) game configuration parameters; and (vi) status of the game.

Furthermore, in accordance with some embodiments of the present disclosure, the configuring of the gamification application comprising receiving parameters related to the one or more agents.

Furthermore, in accordance with some embodiments of the present disclosure, each type of KPI has a preconfigured prediction model.

Furthermore, in accordance with some embodiments of the present disclosure, the operating of the trained machine learning may include: (i) collecting interactions data from the ACD, game data and agents data during a preconfigured time that the game was running; (ii) providing the collected interactions data from the ACD, game data and agents data to the control prediction model to predict the control-KPI for each future period in the plurality of the preconfigured number of future periods when the game is not running; (iii) providing the collected interactions data from the ACD, game data and agents data to the treatment prediction model to predict the treatment-KPI for each future period in the plurality of the preconfigured number of future periods when the new game is running; (iv) calculating a Conditional Average Treatment Effect (CATE) by subtracting a difference between each predicted treatment-KPI and predicted control-KPI in each future period in the plurality of preconfigured number of future periods; and (v) calculating a gradient of the CATE to yield an indication of an impact of the new game on the target KPI.

Furthermore, in accordance with some embodiments of the present disclosure, operating of the optimum-period algorithm may include: (i) determining a grace period where the CATE is stabilized from the beginning of the game and trend is ignored; (ii) generating an outcome-curve by operating a moving average technique for the gradient. The outcome-curve is generated based on averaged K data points; (iii) determine a direction of improvement as one of: negative and positive; and (iv) determining an optimum point using a reversal of trend of the outcome-curve to find a negative direction of improvement which indicates a negative streak of negative values over preconfigured consecutive time-points on the outcome-curve.

There is further provided, in accordance with some embodiments of the present invention, a computerized-system for predicting a game period to motivate agents to reach a target Key Performance Indicator (KPI) in a contact center.

Furthermore, in accordance with some embodiments of the present disclosure, the computerized-system includes a game database and a memory to store the game database; and one or more processors.

Furthermore, in accordance with some embodiments of the present disclosure, the one or more processors may be configured to: (i) train a machine learning model to predict the game period to motivate agents to reach the target KPI; (ii) configure a gamification application to schedule a new game for one or more agents by: a) receive the target KPI, value of the target KPI and a start date for the game to be stored in the game database; b) automatically operate the trained machine learning model to predict the game period to motivate agents to reach the target KPI starting from the received start date for the game; and c) calculate an end date for the game based on the predicted game period; and (iii) configure the gamification application to operate the new game from the received start date till the calculated end date to the one or more agents.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a high-level diagram of a computerized-system for predicting a game period to motivate agents to reach a target Key Performance Indicator (KPI) in a contact center, in accordance with some embodiments of the present invention;

FIG. 2 illustrates a high-level diagram of a computerized-system for predicting a game period to motivate agents to reach a target KPI, in accordance with some embodiments of the present invention;

FIG. 3 illustrates adding a recommended game, in accordance with some embodiments of the present invention;

FIG. 4 illustrates a high-level flowchart of a method for predicting a game period to motivate agents to reach a target Key Performance Indicator (KPI) in a contact center, in accordance with some embodiments of the present invention;

FIG. 5 illustrates training of the machine learning model, in accordance with some embodiments of the present invention;

FIG. 6 illustrates T-learner time series forecast model, in accordance with some embodiments of the present invention;

FIG. 7 illustrates the calculation of a game period negative streak stop, in accordance with some embodiments of the present invention;

FIG. 8 is a graph showing a decline in Average Handling Time (AHT) metric during effective game time, in accordance with some embodiments of the present invention;

FIG. 9 illustrates grace period calculation, in accordance with some embodiments of the present invention;

FIG. 10 illustrates calculation of negative streak stop, in accordance with some embodiments of the present invention;

FIG. 11 shows graphs of results of predicting a game period to motivate agents to reach a target Key Performance Indicator (KPI), in accordance with some embodiments of the present invention;

FIG. 12 shows a graph of results of predicting a game period to motivate agents to reach a target KPI, in accordance with some embodiments of the present invention;

FIG. 13 shows a screenshot of a user interface that implements prediction of a game period to motivate agents to reach a target KPI, in accordance with some embodiments of the present invention; and

FIG. 14 shows a screenshot of a supervisor game view, in accordance with some embodiments of the present invention.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

Gamification has become a key component in performance management solutions. Current gamification applications, which are part of the performance management systems, lack auto game recommendation of the effective time period required to accomplish a performance metric, e.g., Average Handling Time (AHT).

The gamification is making work in the contact centers more engaging and rewarding for agents. It involves integrating game-like operations, such as points, badges, and challenges, into daily tasks to boost motivation and productivity.

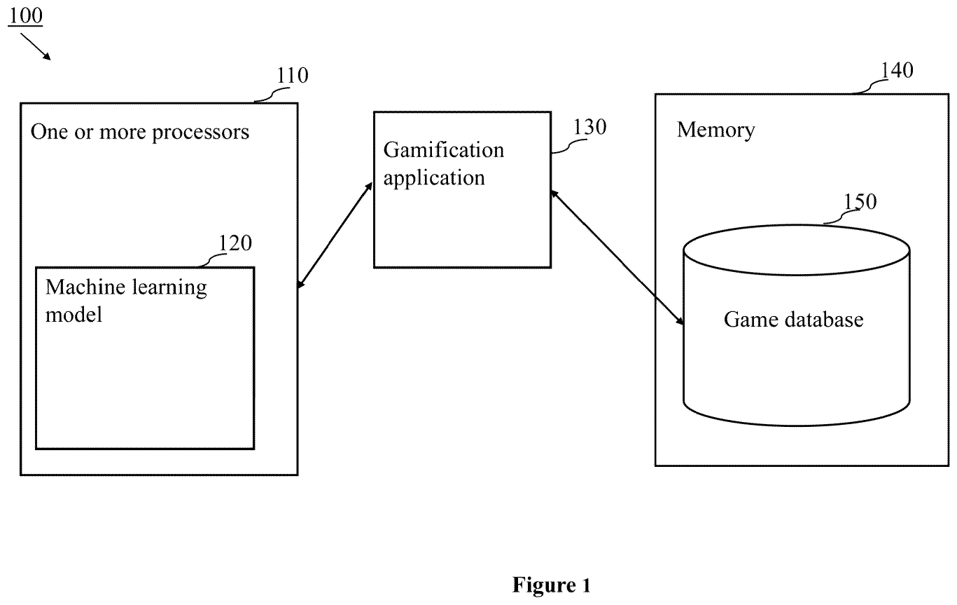

FIG. 1 schematically illustrates a high-level diagram of a computerized-system 100 for predicting a game period to motivate agents to reach a target Key Performance Indicator (KPI) in a contact center, in accordance with some embodiments of the present invention.

According to some embodiments of the present disclosure, a system, such as computerized-system 100 may predict a game period to motivate agents to reach a target Key Performance Indicator (KPI), in a contact center. The computerized-system 100 may be implemented in a performance management system.

According to some embodiments of the present disclosure, the computerized-system 100 may operate one or more processors 110 to train a machine learning model 120 to predict the game period that is required to motivate agents in the contact center to reach the target KPI. The target KPI is a metric that may be reached during the agents' work.

According to some embodiments of the present disclosure, the computerized-system 100 may configure a gamification application 130 to schedule a new game for one or more agents. The gamification application 130 may be configured to schedule the new game by receiving the target KPI, e.g., AHT, value of the target KPI e.g., 2 minutes and a start date for the game. The target KPI, value of the target KPI and the start date may be stored in a game database 150. Then, the trained machine learning model may be automatically operated to predict the required game period to motivate agents to reach the target KPI starting from the received start date for the game. The game database may be kept in the memory 140.

According to some embodiments of the present disclosure, the gamification application 130 may be further configured to schedule the new game by calculating an end date for the game based on the predicted game period to achieve the target KPI. At the end of the predicted game period, on the end date, the gaming application 130 may be configured to stop running the game for the agent.

According to some embodiments of the present disclosure, the gamification application 130 may be configured to operate the new game from the received start date till the calculated end date to the one or more agents.

According to some embodiments of the present disclosure, the training of the machine learning models 120 may include collecting interactions data from the Automatic Call Distributor (ACD), game data and agents' data during a preconfigured time that the game was running and then parsing and merging the collected interactions data and agents' data by a period and agent. The training may further include creating labeled training sets by marking the target KPI and then training a control prediction model to predict a control-KPI for each future period in a plurality of a preconfigured number of future periods when the game is not running.

According to some embodiments of the present disclosure, the interactions data may include average KPIs, interaction type, interaction duration, a timestamp, attributes of agent and game parameters. The agents' data may include skills, KPIs, tenure, team, game configuration parameters, and status of the game. The KPI's data may include KPIs of the agents during the period.

According to some embodiments of the present disclosure, the parsing of the interactions data may include converting non numerical data into numerical data.

According to some embodiments of the present disclosure, causal inference is the process of determining whether a cause-effect relationship exists between two or more variables. It's essential for understanding how changes in one factor, such as game period might directly influence change in KPI which may be increase or decrease, beyond mere correlation.

According to some embodiments of the present disclosure, causal inference AI models are designed to understand and analyze cause-and-effect relationships, which is more than just identifying correlations. This approach is particularly useful to understand the root causes of outcomes.

According to some embodiments of the present disclosure, the T-learner is a meta-learning framework used in causal inference to estimate the Conditional Average Treatment Effect (CATE). It works by building two separate models: one for the treatment group and another for the control group.

According to some embodiments of the present disclosure, the training of the machine learning models may further include training a treatment prediction model 120 to predict a treatment-KPI for each future period in the plurality of the preconfigured number future periods when the new game is running and then generating a KPI-curve from the predicted control-KPI subtracted from the treatment-KPI of each future period in the plurality of the preconfigured number of future periods. The future period of an optimum point on the KPI-curve may be determined as the predicted game period by operating an optimum-period algorithm.

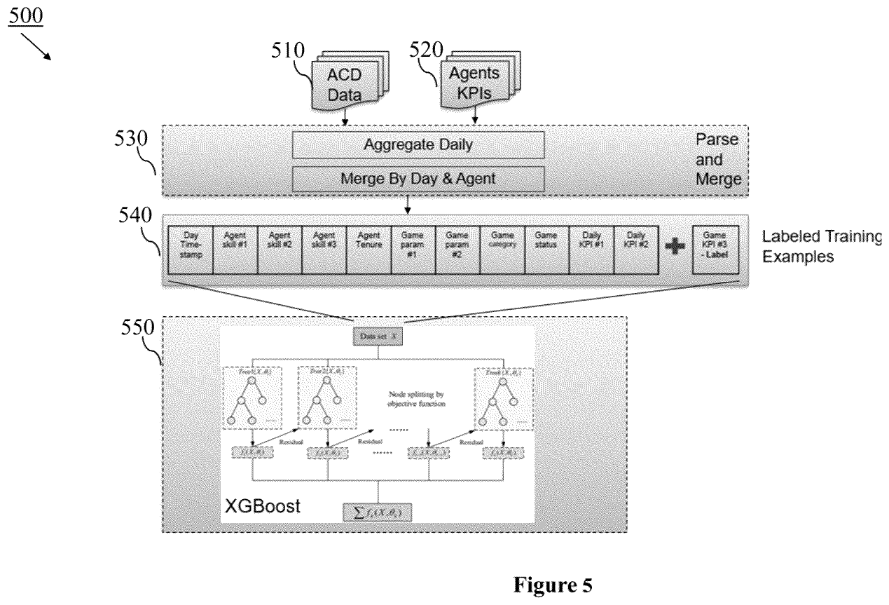

According to some embodiments of the present disclosure, the T-learner is a meta model which is a composite of two time series prediction models. The T-learner is designed in such a way that the base data relevant to the same one or more agents can be ingested to the two sub models. Furthermore, the time series model is provided with a manipulated data structure that is engineered to change the model internal representation for example, as shown in FIG. 5, element 540. The models are trained, to create a model that represents the effect on a KPI of agent attributes, agent metrics over time and agent game participation attributes.

According to some embodiments of the present disclosure, the configuring of the gamification application 130 may include receiving parameters related to the one or more agents.

According to some embodiments of the present disclosure, each type of KPI has a preconfigured prediction model.

According to some embodiments of the present disclosure, for example, prediction models may be a model for Average After Call Work (ACW) time KPI and Adherence KPI percentage, between 0 and 100, which is describing the adherence to the work shift schedule, in addition to the Average Handling Time (AHT). Each of the control and treatment instance models for each T-learner KPI system is improved separately, forming a framework for obtaining and improving T-learner systems that are trained on any indicated KPI per contact center historical data. The target KPI is used to improve a model instance prediction error, by measuring the normalized Mean-Average-Error (MAE) and the normalized Root-Mean-Square-Error (RMSE) of predictions using cross-validation. The normalized MAE or RMSE, or other error measurement method may be used to reach the adapted model.

According to some embodiments of the present disclosure, the operating of the trained machine learning may include collecting interactions data from the ACD, game data and agents data during a preconfigured time that the game was running and then providing the collected interactions data from the ACD, game data and agents data to the control prediction model to predict the control-KPI for each future period in the plurality of the preconfigured number of future periods when the game is not running.

According to some embodiments of the present disclosure, the operating of the trained machine learning may further include providing the collected interactions data from the ACD, game data and agents data to the treatment prediction model to predict the treatment-KPI for each future period in the plurality of the preconfigured number of future periods when the game is running and calculating a Conditional Average Treatment Effect (CATE) by subtracting the difference between each predicted treatment-KPI and predicted control-KPI in each future period in the plurality of preconfigured number of future periods. Then, calculating a gradient of the CATE to yield an indication of an impact of the new game on the target KPI.

According to some embodiments of the present disclosure, the operating of the optimum-period algorithm may include determining a grace period where the CATE is stabilized from the beginning of the game and trend is ignored and then generating an outcome-curve by operating a moving average technique for the gradient. The outcome-curve may be generated based on averaged K data points. The direction of improvement may be determined as one of: negative and positive. An optimum point may be determined using a reversal of trend of the outcome-curve to find a negative direction of improvement which indicates a negative streak of negative values over preconfigured consecutive time-points on the outcome-curve.

According to some embodiments of the present disclosure, the moving average technique calculates the average of k consecutive data points from the K-th data point within the input data. Where k is the window size, set to produce a new sequence of averaged data points, thereby reducing short-term fluctuations, and highlighting long-term trends identification with lag proportional to K. The outcome curve is smother and less volatile.

According to some embodiments of the present disclosure, a causal system is a system where the output at any given time depends only on past and present inputs, but not on future inputs.

According to some embodiments of the present disclosure, computerized-system 100 may operate a combination of Artificial Intelligence (AI) modules, considering agent's behavior and historical data. Casual inference AI models provide concrete cause and effect outcome to gamification.

According to some embodiments of the present disclosure, to construct a feature vector for a time series forecast model, periodic data, such as daily data, may be compiled into a structured format where each row represents a single day. Each row may include various features that capture different aspects of the data.

According to some embodiments of the present disclosure, the features may be for example, daily ACD Data which includes metrics, such as average call duration, average after-call work time, number of interrupted calls, number of calls on hold, and total call volume, skills, which are one-hot encoded to represent the presence or absence of specific skills, KPIs, which are scores ranging from 0 to 100, excluding the target KPI, tenure which represents the duration of employment or involvement, day in week that indicates the specific day of the week, day in year that indicates the specific day of the year, month that indicates the specific month, team which is a string that represents the team name and target KPI which is defined as the game target for the day.

According to some embodiments of the present disclosure, by organizing the data in this manner, computerized-system 100 may ensure that each row that may be represented by a period of time, such as a day, may contain all features, which may enable the AI model to learn patterns and make accurate forecasts based on the historical data.

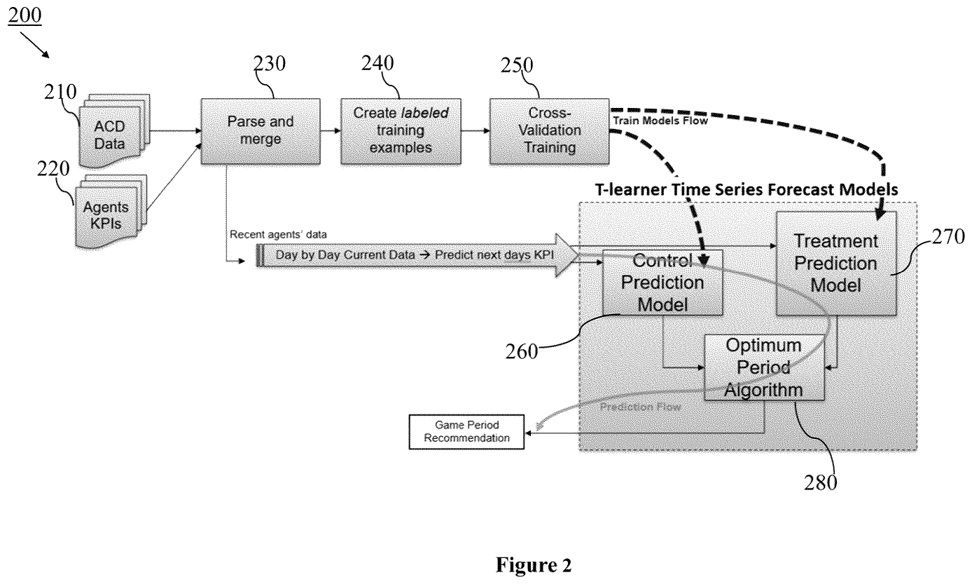

FIG. 2 illustrates a high-level diagram of a computerized-system 200 for predicting a game period to motivate agents to reach a target KPI, in accordance with some embodiments of the present invention.

According to some embodiments of the present disclosure, computerized-system 200 may have the same components as computerized-system 100 in FIG. 1.

According to some embodiments of the present disclosure, computerized-system 200 may gather ACD data 210 from past contact center interactions and preconfigured agent KPIs 220 from various sources. This data may be aggregated periodically, e.g., daily during the preparation phase, merging workload interaction data with KPIs to identify relevant daily interactions.

According to some embodiments of the present disclosure, during the training phase of the AI models, labeled training datasets may be created to mark KPI targets, which are then fed into a training framework. This framework performs cross-validation and trains both control and treatment e.g., T-learner for two, time series forecast model. The treatment model 270 predicts outcomes when agents engage with a game, while the control model 260 predicts outcomes without the game.

According to some embodiments of the present disclosure, once trained, these models may be ready for inference. For new game recommendations, as part of performance management, recent ACD data and agent KPIs may be parsed, merged, and fed periodically, e.g., daily, into the AI models to predict the next period, e.g., day's KPI. The control model 260 predicts KPIs without the game, and the treatment model 270 predicts KPIs with game parameters.

According to some embodiments of the present disclosure, periodic predictions, e.g., daily predictions may be used to produce data for an optimal period algorithm, which analyzes KPI data curves to recommend the best game periods.

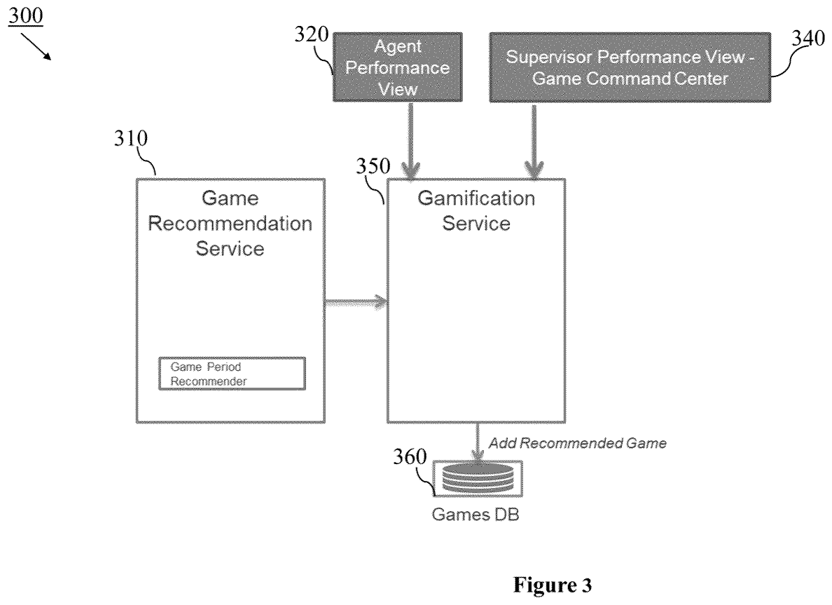

FIG. 3 illustrates adding a recommended game, in accordance with some embodiments of the present invention.

According to some embodiments of the present disclosure, computerized-system 100 in FIG. 1 may be implemented as a game recommendation service 310 to provide a game period recommender for a game service 350. The new recommended game parameters may include the agent identification for which the game is recommended and automatically assigned, the game period in days and additional attributes that define the game, such as the KPI name and KPI target values.

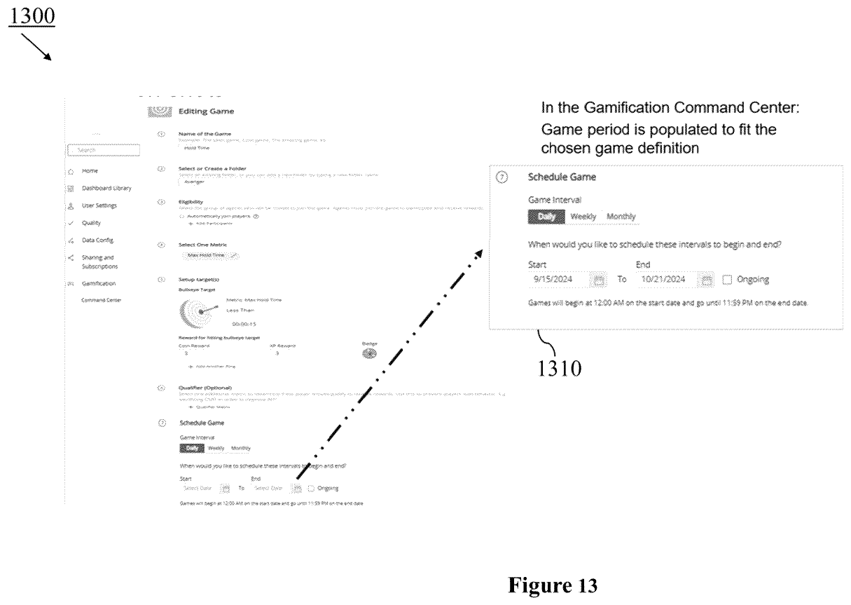

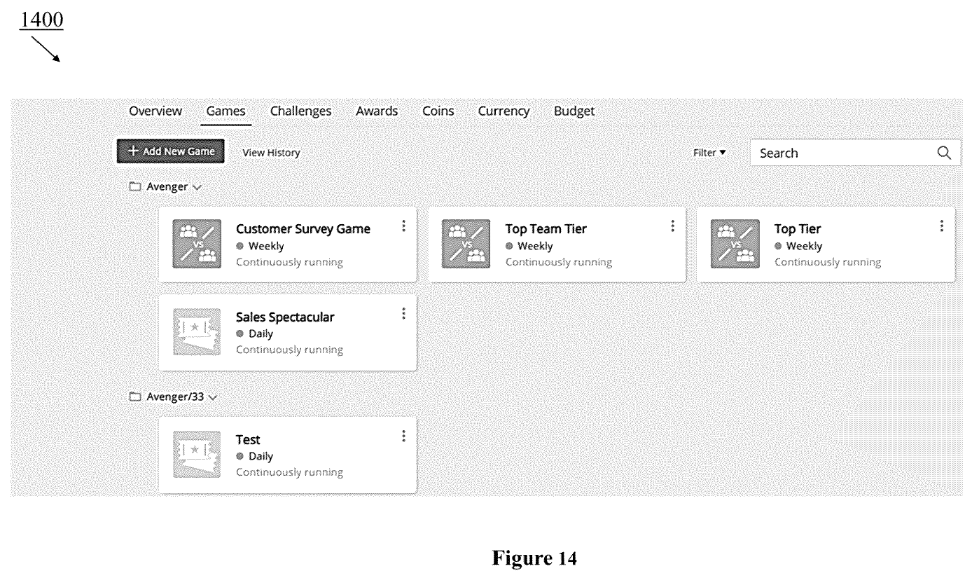

According to some embodiments of the present disclosure, the game parameters are saved in the games DB and used by the gamification software service, the game then appears in the agent's performance view and in the supervisor games ‘command center’ view. For example, as shown in FIGS. 13 and 14.

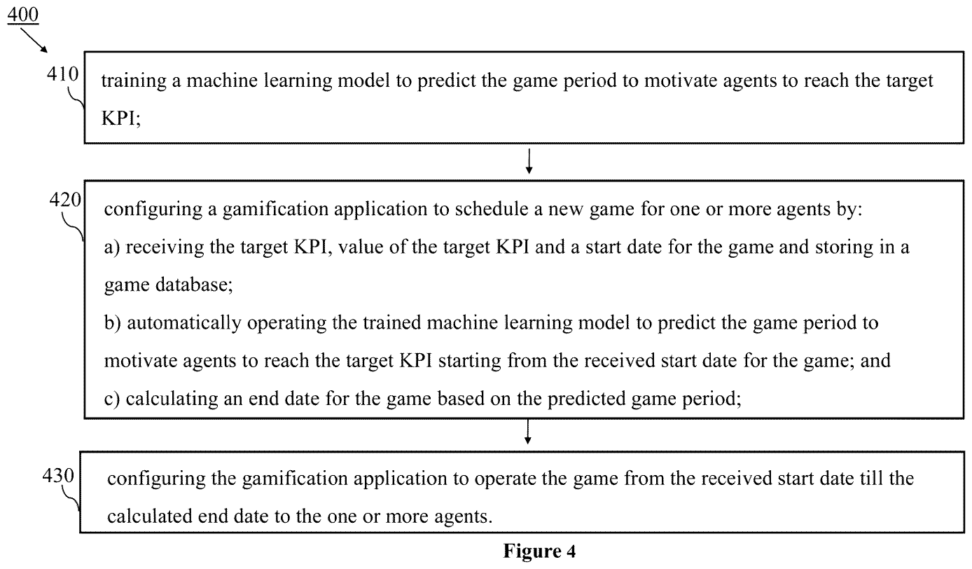

FIG. 4 illustrates a high-level flowchart of a method for predicting a game period to motivate agents to reach a target Key Performance Indicator (KPI) in a contact center, in accordance with some embodiments of the present invention.

According to some embodiments of the present disclosure, operation 410 comprising training a machine learning model to predict the game period to motivate agents to reach the target KPI.

According to some embodiments of the present disclosure, operation 420 comprising configuring a gamification application to schedule a new game for one or more agents by:
a) receiving the target KPI, value of the target KPI and a start date for the game and storing in a game database;
b) automatically operating the trained machine learning model to predict the game period to motivate agents to reach the target KPI starting from the received start date for the game; and
c) calculating an end date for the game based on the predicted game period

According to some embodiments of the present disclosure, operation 430 comprising configuring the gamification application to operate the new game from the received start date till the calculated end date to the one or more agents.

FIG. 5 illustrates training of the machine learning model, in accordance with some embodiments of the present invention.

According to some embodiments of the present disclosure, in a system, such as computerized-system 100 in FIG. 1 and such as computerized-system 200 in FIG. 200, the system may gather ACD data 510 from past contact center interactions and preconfigured agent KPIs 520 from various sources. This data may be aggregated periodically, e.g., daily, during the preparation phase, merging workload interaction data with KPIs to identify relevant periodic, e.g., daily interactions.

According to some embodiments of the present disclosure, in the training phase, e.g., in a machine learning library 550 that provides an implementation of gradient boosting, for example, such as eXtreme Gradient Boosting (XGBoost), labeled training sets 540 may be created to mark KPI targets, which are then fed into the training framework. This framework performs cross-validation and trains both control and treatment models, e.g., T-learner, time series forecast model. The treatment model predicts outcomes when agents engage with a game, while the control model predicts outcomes without the game.

According to some embodiments of the present disclosure, once trained, the models may be ready for inference. For new game recommendations, recent ACD data and agent KPIs are parsed, merged, and fed daily into the models to predict the next day's KPI. The control model predicts KPIs without the game, and the treatment model predicts KPIs with game parameters.

According to some embodiments of the present disclosure, periodic predictions, e.g., daily predictions may be used to produce data for an optimal period algorithm, which analyzes KPI data curves to recommend the best game periods.

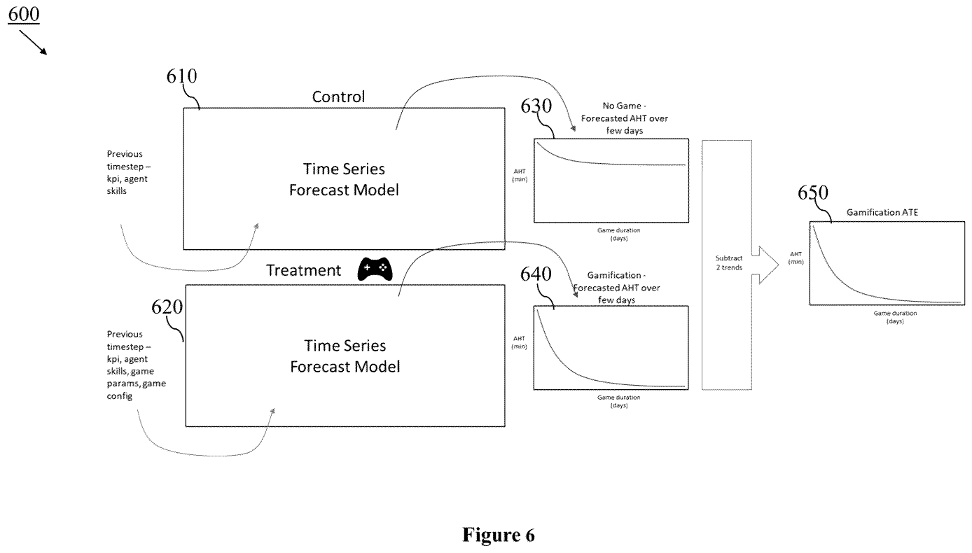

FIG. 6 illustrates T-learner time series forecast model, in accordance with some embodiments of the present invention.

According to some embodiments of the present disclosure, in computerized-system 100 in FIG. 1 and computerized-system 200 in FIG. 2, once the models are trained, they may be used for the prediction phase. The T-learner model may be used by feeding it recent data for a newly defined game. For a specific agent with certain attributes, the data may be fed into the control model, which predicts the target KPI, e.g., AHT, as if the agent is not playing the game. This produces a periodic, e.g., daily KPI curve.

According to some embodiments of the present disclosure, the same data may be fed, along with game parameters, into the treatment prediction model, generating a different KPI curve as if the agent or group of agents is playing the game. This process may be repeated periodically, e.g., daily over a period of months, creating two KPI curves for the two scenarios. By subtracting these curves, the delta averaged treatment effect of gamification may be obtained, which shows the improvement in the KPI, e.g., AHT.

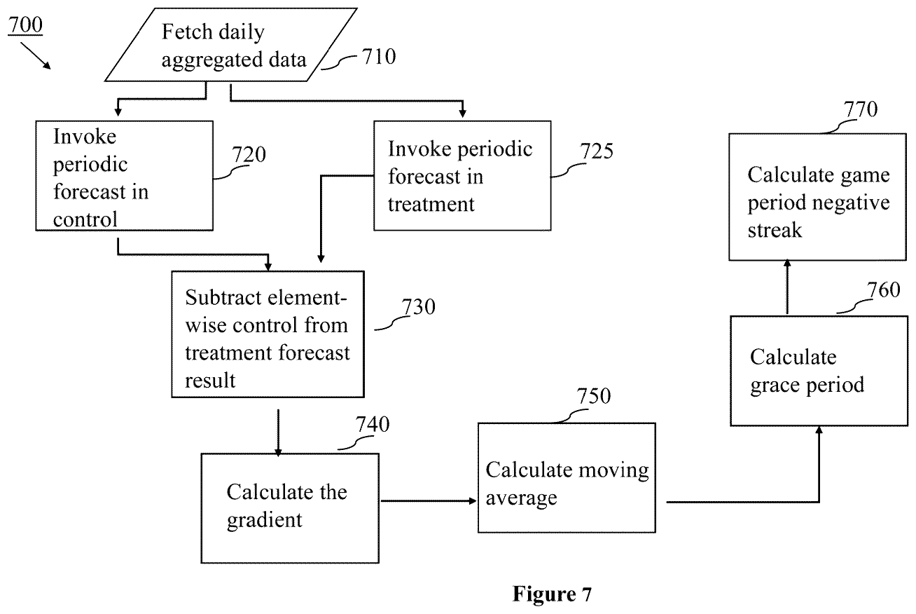

FIG. 7 illustrates the calculation of a game period negative streak stop, in accordance with some embodiments of the present invention.

According to some embodiments of the present disclosure, in a system, such as computerized-system 100 in FIG. 1 and such as computerized-system 200 in FIG. 200, periodic data, e.g., daily data may be fetched and aggregated 710. The data may represent a metric of interest, e.g., AHT which may be collected over time.

According to some embodiments of the present disclosure, periodic data, e.g., 60-days forecast, may be invoked in control 720 and in treatment 725. For example, the algorithm may generate two separate 60-day forecasts. One forecast may represent the “control” group, and the other may represent the “treatment” group. These forecasts use historical data and statistical models to predict future values of the metric.

According to some embodiments of the present disclosure, operating Conditional Average Treatment Effect (CATE) by subtracting element-wise control from treatment forecast result 730. The difference between the treatment and control forecasts for each period, e.g., day in the 60-day period may be calculated. This difference represents the estimated impact of the treatment on the metric.

According to some embodiments of the present disclosure, the CATE has a specific type of causal effect. It is the average effect of the treatment or exposure on a sub-group. The validity of the estimate is conditional on being part of this subgroup, a subgroup can be one person. CATE refers to the difference in the expected value of the outcome variable between two groups of individuals who differ only in their treatment status but are otherwise similar in terms of their observed characteristics or covariates.

According to some embodiments of the present disclosure, for each period, e.g., day, KPIs are generated by the forecast models. For the period a KPI curve is created as if the agent or group of agents is playing the game and a different curve for as if he is not playing. By subtracting these curves, the delta averaged treatment effect of gamification may be obtained, which shows the improvement in the KPI, e.g., AHT. This subtraction is game effect: the KPI CATE.

According to some embodiments of the present disclosure, the gradient may be calculated 740. The gradient may be calculated for the CATE, the difference between treatment and control. The gradient represents the rate of change of the treatment effect over time. The gradient helps identify trends and potential turning points in the impact of the treatment.

According to some embodiments of the present disclosure, first-order derivative for a series of numbers, representing the KPI CATE curve, involves finding the rate of change between consecutive elements in the series. Since the interval is, for example, one day between KPI elements, then there is no need to divide by interval.

While y_i denotes the KPI cate on day i, the gradient Δy_i for each day may be calculated by:

Δy_i=y_i−y_(i−1)

According to some embodiments of the present disclosure, calculating moving average 750, e.g., with window size 10. A 10-day moving average is calculated for the gradient. This smooths out fluctuations and noise in the gradient, making it easier to identify longer-term trends and patterns.

According to some embodiments of the present disclosure, for example, when the series of KPI CATE gradients is denoted as y=[y₁, y₂, . . . yₙ] with window size of 10, the moving average may be calculated for each position i in the series, compute the average of the values from yᵢ to yᵢ₊₉.

According to some embodiments of the present disclosure, the moving average at position i is given by:

$${MA}_{i} = \frac{1}{k} {\sum }_{j = 0}^{i + k - 1} {y}_{i}$$

According to some embodiments of the present disclosure, this calculation is repeated for each position i from 1 to n−k+1.

According to some embodiments of the present disclosure, the CATE represents the delta improvement of the game's target KPI, predicted daily to create a curve over time. This effect is conditioned by the game and agent attributes. The algorithm identifies points on the curve where improvement stops, indicating the game's effectiveness has plateaued or is measurable.

According to some embodiments of the present disclosure, to account for volatility, the algorithm includes several phases. First, it calculates the gradient to describe the direction and strength of improvement. This gradient is then smoothed using e.g., a 10-day moving average, to produce the ‘gradient sign’ for every day. In the final phase, ‘Negative Streak Stop’ algorithm, looks for a preconfigured number of consecutive negative days, e.g., five consecutive negative days, to signal the end of a positive trend. Additionally, a grace period of 12 to 22 days is included at the beginning of the game to allow for higher volatility, based on data evidence.

According to some embodiments of the present disclosure, the grace period may be calculated 760. The “grace period” may be determined based on the smoothed gradient. This period represents a time window where the treatment effect is considered to be stabilizing or showing positive signs after a potential negative period.

According to some embodiments of the present disclosure, the grace period is calculated using cumulative standard deviation up to time t. This formula combines the calculation of the cumulative mean and the cumulative variance and then takes the square root to obtain the cumulative standard deviation.

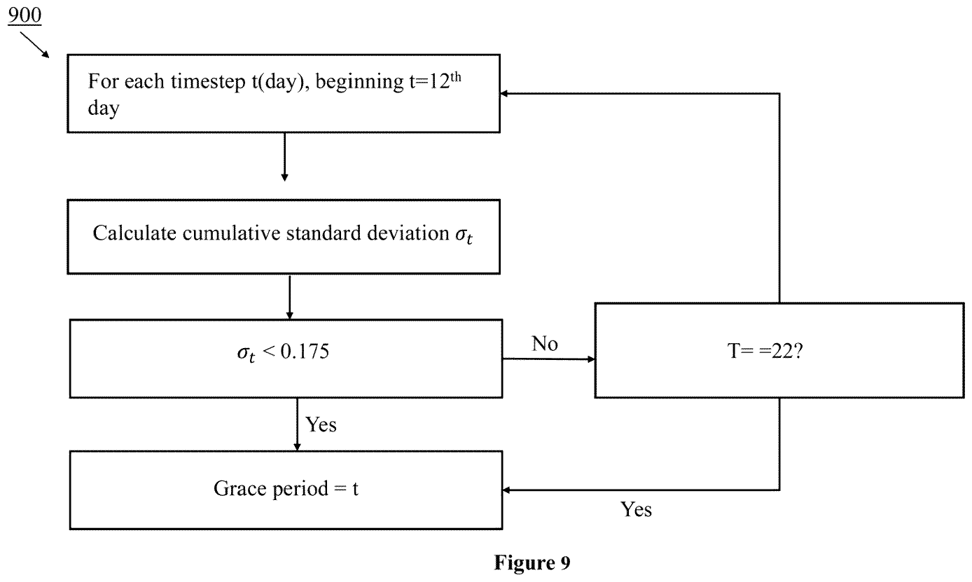

According to some embodiments of the present disclosure, at is calculated between t=10 up until t=22, when σₜ<0.175 (under the threshold) further calculations are not needed, and this t is the grace period. If the threshold is not reached, then t=22. For example, as shown in FIG. 9.

According to some embodiments of the present disclosure, calculating game period negative streak stop 770. The “game period” to achieve the target KPI may be defined, and the algorithm identifies when a “negative streak” stops. This involves monitoring the moving average of the gradient to detect a sustained period of negative impact e.g., negative streak and identifying when the trend reverses, signaling the end of the streak. The “game period” represents the time frame where the treatment effect is expected to be fully realized or evaluated.

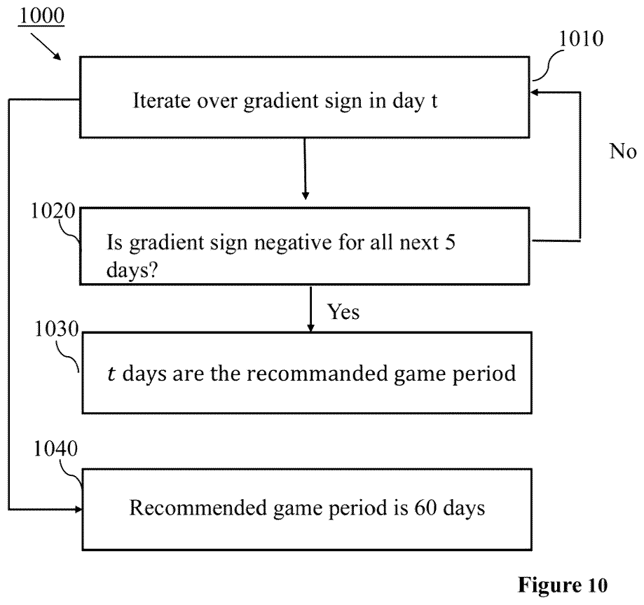

According to some embodiments of the present disclosure, in time series forecasting, trends and patterns can change over time. By using a criterion, such as five consecutive negative days ahead, the method adapts to the dynamic nature of time series data, ensuring that the model remains relevant and accurate. Overall, this early negative streak stop method is a practical and effective way to enhance model performance and reliability in time series forecasting and other sequential data tasks. For example, as shown in FIG. 10.

According to some embodiments of the present disclosure, computerized-system 100 in FIG. 1 and computerized-system 200 in FIG. 2 may forecast the impact of a treatment over time, identify trends in the treatment effect using the gradient and moving average, define periods of stability or improvement, e.g. grace period and periods for evaluation e.g., game period, and detect and analyze negative streaks in the treatment effect.

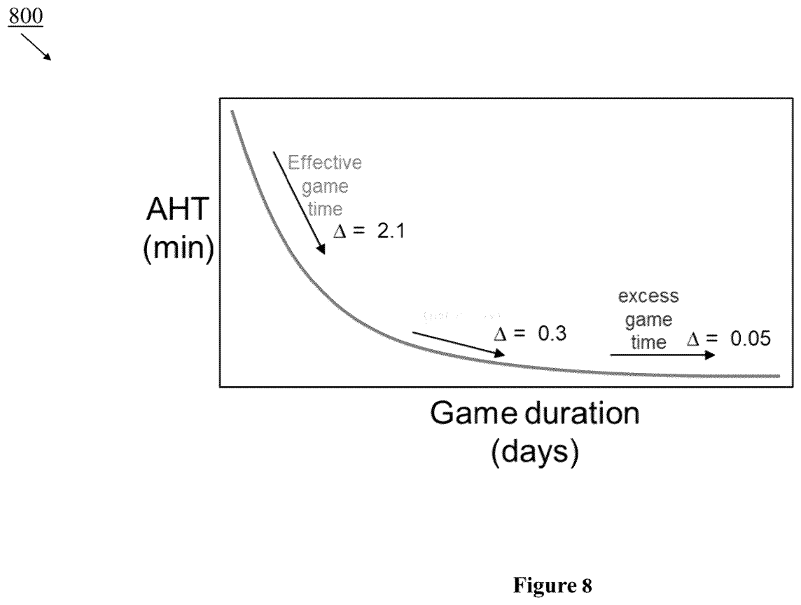

FIG. 8 is a graph 800 showing a decline in Average handle time (AHT) metric during effective game time, in accordance with some embodiments of the present invention.

According to some embodiments of the present disclosure, in a system, such as computerized-system 100 in FIG. 1, and such as computerized-system 200 in FIG. 2, a game period to motivate agents to reach a target Key Performance Indicator (KPI), in a contact center may be predicted when a new game is configured via a User Interface (UI), such as UI 1300 in FIG. 13.

According to some embodiments of the present disclosure, the effective game time to motivate the agents to reach a target KPI, such as AHT, may be represented by the curve in graph 800.

FIG. 9 illustrates grace period calculation, in accordance with some embodiments of the present invention.

According to some embodiments of the present disclosure, in a system, such as computerized-system 100 in FIG. 1, and such as computerized-system 200 in FIG. 2, the grace period may be calculated using cumulative standard deviation up to time t. The formula combines the calculation of the cumulative mean and the cumulative variance, and then takes the square root to obtain the cumulative standard deviation.

According to some embodiments of the present disclosure, the cumulative mean up to time t may be calculated according to formula I:

### (I) Cumulative Mean Up to Time t:

$${μ}_{t} = \frac{1}{t} {\sum }_{i = 1}^{t} {x}_{i}$$

where xᵢ is the value at time i.

According to some embodiments of the present disclosure, the cumulative variance up to time t may be calculated according to formula II:

### (II) Cumulative Variance Up to Time t:

$${σ}^{2} = \frac{1}{t} {\sum }_{i = 1}^{t} {( {x}_{i} - {μ}_{t} )}^{2}$$

According to some embodiments of the present disclosure, the cumulative standard deviation up to time t may be calculated according to formula III:

### (III) Cumulative Standard Deviation Up to Time t:

$${σ}_{t} = \sqrt{{σ}_{t}^{2}}$$

σₜ is calculated between t=10 up until t=22, when σₜ<0.175 i.e., under the threshold, further calculations are not needed, and this t is the grace period. If the threshold is not reached, then t=22.

FIG. 10 illustrates calculation of negative streak stop, in accordance with some embodiments of the present invention.

According to some embodiments of the present disclosure, in a system, such as computerized-system 100 in FIG. 1, and such as computerized-system 200 in FIG. 2, the calculation of negative streak stop may be operated by iterating over gradient sign in day t 1010 in each iteration checking is gradient sign negative for all next preconfigured of number of days, e.g. 5 days 1020.

According to some embodiments of the present disclosure, the t days will be the recommended game period 1030. For example, the recommended game period may be 60 days when t=60 1040.

According to some embodiments of the present disclosure, in time series forecasting, trends and patterns can change over time. By using a criterion like preconfigured number of days, e.g., five consecutive negative days ahead, the method adapts to the dynamic nature of time series data, ensuring that the model remains relevant and accurate.

According to some embodiments of the present disclosure, overall, this early negative streak stop method is a practical and effective way to enhance model performance and reliability in time series forecasting and other sequential data tasks.

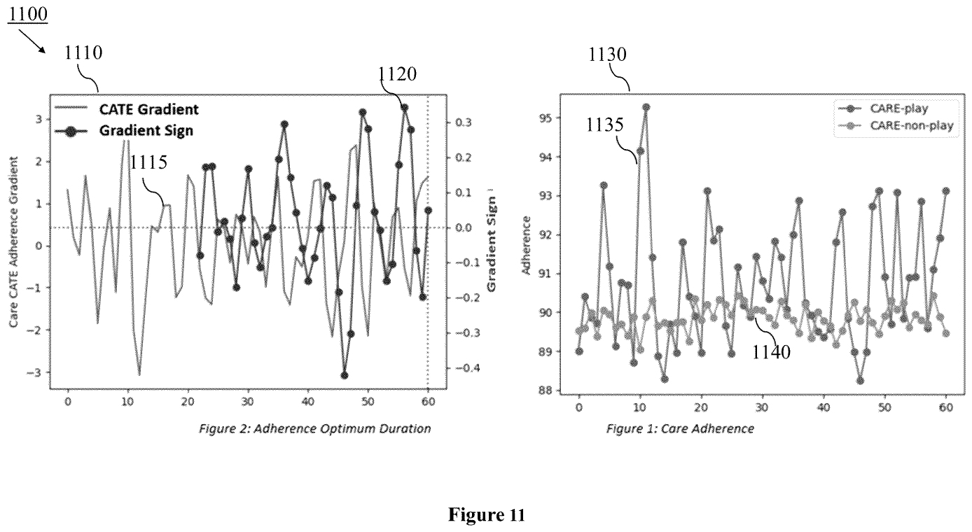

FIG. 11 are graphs of results of predicting a game period to motivate agents to reach a target Key Performance Indicator (KPI), in accordance with some embodiments of the present invention.

According to some embodiments of the present disclosure, in a system, such as computerized-system 100 in FIG. 1, and such as computerized-system 200 in FIG. 2, to determine the optimal game period, graph 1110 shows CATE gradient analysis over the 60 days period. Curve 1115 represents the CATE gradient. The CATE is calculated by taking curve 1140, control Adherence KPI, in graph 1130 subtracted from the curve 1135, treatment Adherence KPI. The CATE gradient in curve 1115 in graph 1110, is the difference between CATEs of successive days. The gradient sign curve 1120 represents the 10-day moving average, starting after 22 days due to the calculated grace period. This gradient sign curve 1120 represents how long to run the game. In this example, the game ends at day 60 as the negative trend threshold of 5 days streak ahead was not met before the full prediction period concluded.

According to some embodiments of the present disclosure, graph 1130 illustrates the CARE team of contact center agents' adherence KPI over 60 days. The care play curve 1135 represents predictions for agents KPI while playing the game, while the care non play curve 1140 shows predictions for those agents as if they are not playing at all. The X-axis represents days, Y-axis, adherence, is the game target in percentage i.e., how much the agent adhered to the daily work. The care non play curve 1140, for the as-if non-playing, suggests adherence remains steady throughout the entire 60 days period. In contrast, the care play curve 1135, for the playing, provide a different situation that shows how the KPI improves as compared to care non play curve 1140.

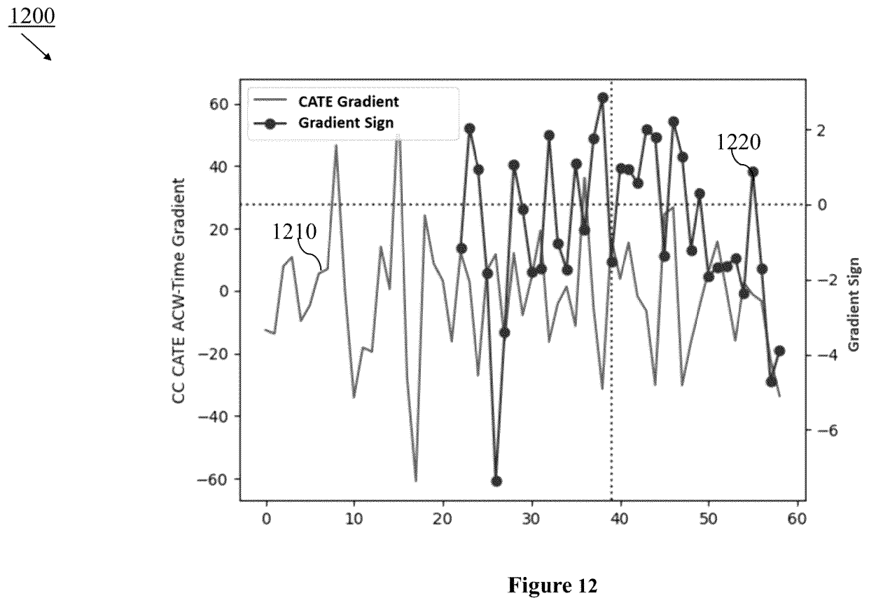

FIG. 12 is a graph of results of predicting a game period to motivate agents to reach a target KPI, in accordance with some embodiments of the present invention.

According to some embodiments of the present disclosure, it is expected to have a positive 5 day streak ahead, i.e., positive or negative is determined by the KPI itself. In the graph, showing the smoothed gradient curve 1220 for the After Call Work (ACW) KPI, the game is set to 39 days because the following days include five instances of positive values. Curve 1210 represents the CATE gradient.

FIG. 13 is a screenshot of a user interface 1300 that implements prediction of a game period to motivate agents to reach a target KPI, in accordance with some embodiments of the present invention.

According to some embodiments of the present disclosure, the user interface 1300 may include a new game definition page. The page includes various parameters, such as the targeted team, KPI, game type, and game budget, which are manually entered. The ‘Schedule Game’ section 1310 may be automatically populated by the implementation of a system, such as system 100 in FIG. 1 and such as system 200 in FIG. 2, which determines the optimal game period and based on the start date populates the end date.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for predicting a game period to motivate agents to reach a target Key Performance Indicator (KPI), in a contact center, said computerized-method comprising:
(i) training a machine learning model to predict the game period to motivate agents to reach the target KPI;
(ii) configuring a gamification application to schedule a new game for one or more agents by:
a) receiving the target KPI, value of the target KPI and a start date for the game and storing in a game database;
b) automatically operating the trained machine learning model to predict the game period to motivate agents to reach the target KPI starting from the received start date for the game; and
c) calculating an end date for the game based on the predicted game period; and
(iii) configuring the gamification application to operate the new game from the received start date till the calculated end date to the one or more agents.

2. The computerized-method of claim 1, wherein the training of the machine learning models comprising:
(i) collecting interactions data from the Automatic call distributor (ACD), game data and agents' data during a preconfigured time that the game was running;
(ii) parsing and merging the collected interactions data and agents' data by a period and agent;
(iii) creating labeled training sets by marking the target KPI;
(iv) training a control prediction model to predict a control-KPI for each future period in a plurality of a preconfigured number of future periods when the game is not running;
(v) training a treatment prediction model to predict a treatment-KPI for each future period in the plurality of the preconfigured number future periods when the new game is running;
(vi) generating a KPI-curve from the predicted control-KPI subtracted from the treatment-KPI of each future period in the plurality of the preconfigured number of future periods; and
(vii) determining the future period of an optimum point on the KPI-curve as the predicted game period by operating an optimum-period algorithm.

3. The computerized-method of claim 2, wherein said interactions data comprising: (i) average KPIs; (ii) interaction type; (iii) interaction duration, (iv) a timestamp; (v) attributes of agent; and (vi) game parameters, and wherein the agents data comprising: (i) skills; (ii) KPIs; (iii) tenure; (iv) team; (v) game configuration parameters; and (vi) status of the game.

4. The computerized-method of claim 1, wherein the configuring of the gamification application comprising receiving parameters related to the one or more agents.

5. The computerized-method of claim 1, wherein each type of KPI has a preconfigured prediction model.

6. The computerized-method of claim 2, wherein the operating of the trained machine learning comprising:
(i) collecting interactions data from the ACD, game data and agents' data during a preconfigured time that the game was running;
(ii) providing the collected interactions data from the ACD, game data and agents data to the control prediction model to predict the control-KPI for each future period in the plurality of the preconfigured number of future periods when the game is not running;
(iii) providing the collected interactions data from the ACD, game data and agents data to the treatment prediction model to predict the treatment-KPI for each future period in the plurality of the preconfigured number of future periods when the new game is running;
(iv) calculating a Conditional Average Treatment Effect (CATE) by subtracting a difference between each predicted treatment-KPI and predicted control-KPI in each future period in the plurality of preconfigured number of future periods; and
(v) calculating a gradient of the CATE to yield an indication of an impact of the new game on the target KPI.

7. The computerized-method of claim 2, wherein said operating of the optimum-period algorithm comprising:
(i) determining a grace period where the CATE is stabilized from the beginning of the game and trend is ignored;
(ii) generating an outcome-curve by operating a moving average technique for the gradient,
wherein the outcome-curve is generated based on averaged K data points;
(iii) determine a direction of improvement as one of: negative and positive; and
(iv) determining an optimum point using a reversal of trend of the outcome-curve to find a negative direction of improvement which indicates a negative streak of negative values over preconfigured consecutive time-points on the outcome-curve.

8. A computerized-system for predicting a game period to motivate agents to reach a target Key Performance Indicator (KPI) in a contact center, said computerized-system comprising:
a game database and a memory to store the game database; and
one or more processors, said one or more processors are configured to:
(i) train a machine learning model to predict the game period to motivate agents to reach the target KPI;
(ii) configure a gamification application to schedule a new game for one or more agents by:
a) receive the target KPI, value of the target KPI and a start date for the game to be stored in the game database;
b) automatically operate the trained machine learning model to predict the game period to motivate agents to reach the target KPI starting from the received start date for the game; and
c) calculate an end date for the game based on the predicted game period; and
(iii) configure the gamification application to operate the new game from the received start date till the calculated end date to the one or more agents.
